(19) United States
(12) Patent Application Publication
(10) Pub. No.: US 2009/0039225 A1
(43) Pub. Date: Feb. 12, 2009

(54) Surfcraft Holder

(76) Inventor: Michael Taylor, New South Wales (AU)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 12/066,021

(22) PCT Filed: Sep. 6, 2006
(86) PCT No.: PCT/AU2006/001306

§ 371 Date: Aug. 11, 2008

(30) Foreign Application Priority Data
Sep. 7, 2005 (AU) 2005904923
Mar. 31, 2006 (AU) 2006901696

(51) Int. Cl. B63B 35/85; A47F 5/08; F16M 13/02; A47F 7/00

(52) U.S. Cl. 248/316.8; 211/85.7; 211/89.01

(57) ABSTRACT

A holder (10) for holding surfcraft S comprises a first member (12) and a second member (14) projecting from a base (16). At least one of the first or second members is able to flex with respect to the base. The first and second members are spaced such that a surfcraft may be positioned sideways and interferingly between the members, whereby the at least one member can flex to receive the surfcraft interferingly therebetween.

### TECHNICAL FIELD

A holder for holding surfcraft in typically either an upright or horizontal configuration is disclosed. Such surfcraft include surfboards, wave jumpers, sail boards, wake boards, surf skis, body boards etc.

### BACKGROUND ART

Known holders for holding surfcraft in an upright configuration include poles, posts and other rigid rack-like devices. Such holders comprise at least two adjacent and parallel posts projecting laterally from a stand. A standing surfcraft is then positioned sideways between the two posts.

### SUMMARY OF DISCLOSURE

In one aspect there is provided a holder for holding surfcraft, the holder comprising first and second members projecting from a base, with at least one of the first or second members being able to flex with respect to the base, and wherein the first and second members are spaced such that a surfcraft may be positioned sideways and interferingly between the members, whereby the at least one member can flex to receive the surfcraft interferingly therebetween.

The flexing of the at least one member enables a surfcraft to be frictionally held between the members, resulting in more secure craft retention in the holder. The holder can also provide improved retention where eg. multiple surfcraft requiring transportation, storage or display are arranged together.

In one form both the first and second members can flex with respect to the base. This can make it easier to position and remove a surfcraft, as both members may flex outwardly when receiving the surfcraft interferingly therebetween and when removing the surfcraft, and can enable easy surfcraft removal.

In this form each of the members and base can be formed as an integral unit, and this may further assist with member flexing in use. For example, the base may also be flexible.

In an embodiment each member may be defined in the form of a flexible finger, each finger being spaced apart and extending outwardly from a respective opposing end of the base. Such finger shaping can enhance surfcraft gripping and thus retention.

Further, in this embodiment, one of the fingers may be adapted to curve or bend inwardly at a distal end thereof towards the other finger, which may itself be straight. This can define a type of throat configuration at the entrance space between the fingers and into which a side of the surfcraft can be inserted during receipt of the surfcraft in the holder between the fingers. Also, during insertion, the curve or bend in the one finger may cause it to flex to a greater extent than the other finger, imparting a tension in that finger that increases the holding force of the holder. The straight finger can also receive thereagainst any relatively flat surface of a surfcraft.

In one form the base may comprise a relatively rigid backing to facilitate its firm mounting to a support (eg. to an upright frame). The rigid backing may be adhered to a remainder of the base and may further comprise an adhesive-backed rear surface, with a removable film cover thereover, the removal of which enables the base to be adhesively mounted to the support.

In another form the rigid backing can be a separate end cap attachable to the base via fasteners. The end cap can be attachable to the support via an adhesive film or tape that is attached to an external end face of the end cap, with a removable film cover being positioned over the film or tape, the removal of which enables the end cap to be adhesively mounted to the support.

In one form the holder can be formed from a polymeric foam material, to provide both flexibility and sufficient structural integrity to enable it to function repeatedly as a surfcraft holder. The polymeric foam material can also enhance the frictional holding of the surfcraft between the members.

The holder may also be laminar, comprising layers of polymeric foam materials of differing densities and/or structure (eg. closed-cell and open-cell polymeric foams). Some layers can be relatively more rigid and structurally stable than others. This laminar arrangement can thereby provide both flexibility and strength to the holder.

In a typical mode of use the holder is positioned on a support so as to hold a surfcraft in an upright configuration, or one or more holders may be positioned to hold a surfcraft in a horizontal configuration etc.

The holder can find a most particular application with surfboards or the like.

### BRIEF DESCRIPTION OF DRAWINGS

Notwithstanding any other forms that may fall within the scope of the holder as defined in the Summary, specific embodiments of the holder will now be described, by way of example only, with reference to the accompanying drawings in which:

FIG. 1 shows a perspective view of a first holder for holding surfcraft;

FIG. 2 shows a perspective view of the holder of FIG. 1 with a surfcraft positioned therein;

FIG. 3 shows a perspective view of a number of the holders of FIG. 1 in a side-by-side configuration, with a number of respective surfcraft positioned therein;

FIG. 4 shows an exploded perspective view of a second holder for holding surfcraft;

FIGS. 5A and 5B show front and rear perspective views of a mounting plate of the second holder of FIG. 4;

FIG. 6 shows an exploded perspective view of a third holder for holding surfcraft; and

FIG. 7 shows a front perspective view of a mounting plate and pin of the third holder of FIG. 6.

### DETAILED DESCRIPTION OF SPECIFIC EMBODIMENTS

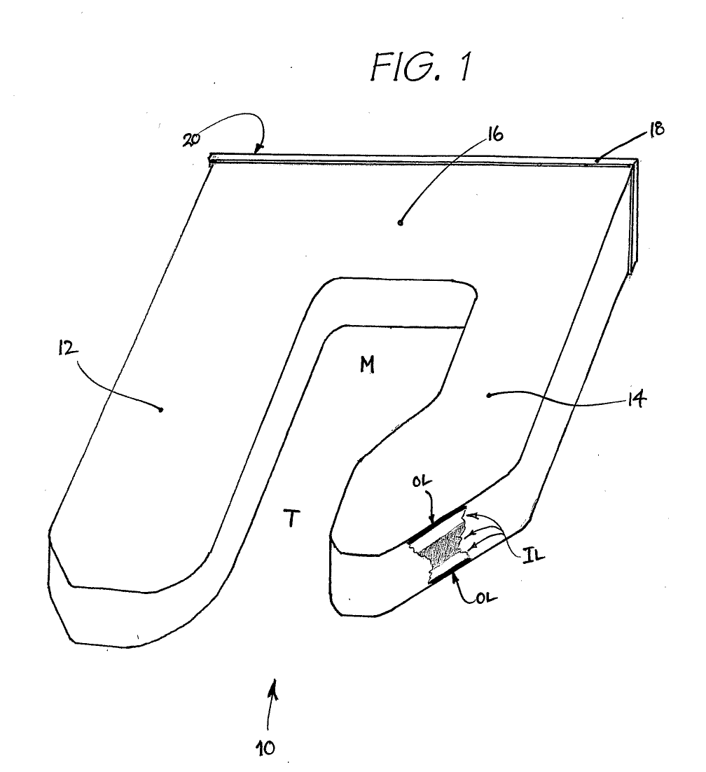

Referring firstly to FIG. 1 a first holder in the form of a rack 10 for holding surfcraft such as surfboards and the like is shown. The rack comprises a first member in the form of a straight finger 12 and a second member in the form of a curved or bent finger 14. The finger 14 as shown is curved or bent inwardly at a distal end thereof towards the other finger, but it may progressively curve or bend along its length. The straight finger 12 can also receive thereagainst the flat underside surface of a surfboard to enhance retention in the rack (ie. because a greater area of the board underside surface is clamped against the straight finger inside surface by the action on the board of the opposing curved finger).

At least the finger 14 is formed of a flexible material to enable it to flex with respect to a base region 16. In this regard, each finger 12, 14 projects from opposite respective ends of the base region 16 and each is typically integrally formed therewith. When so integrally formed, each finger and the base region may be formed from the same flexible material and so all can flex simultaneously to make it easier to position and remove a surfboard in the rack, and such that the holder grips the board in use. The integral formation can also assist with a controlled and repeatable finger flexing in use.

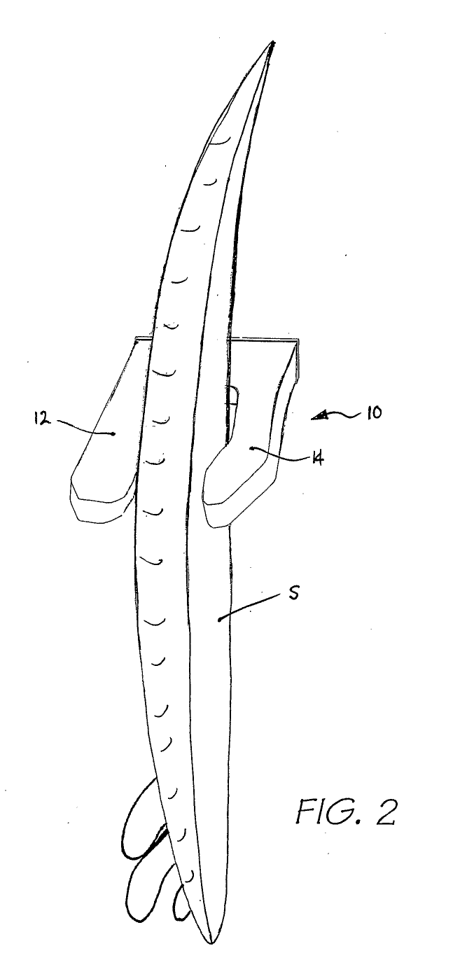

Referring now to FIG. 2, it will be seen that the fingers 12, 14 are spaced such that a surfcraft in the form of a surfboard S may be positioned sideways and interferingly between the fingers to be held thereby in a kind of gripping action, thereby enhancing board retention. In this regard, the fingers each flex outwardly to receive the surfcraft interferingly therebetween. The flexing of the fingers 12, 14 (and additionally the material of their formation) enables the surfboard S to be frictionally held between the fingers, resulting in a more secure retention in the rack 10.

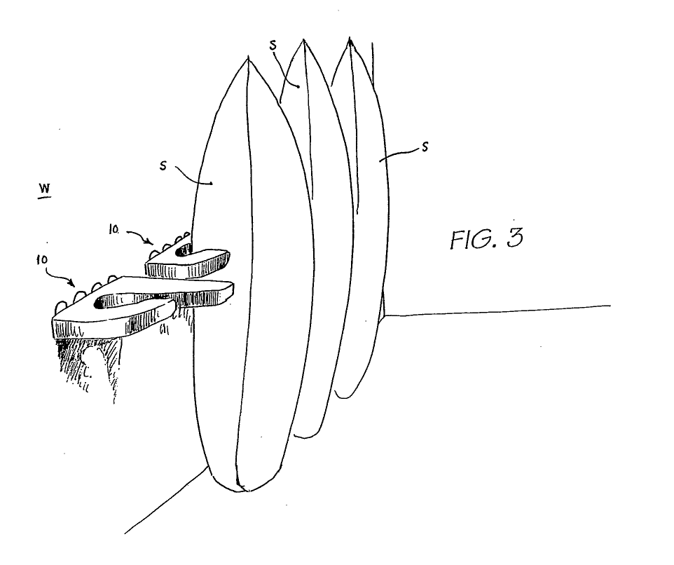

Referring now to FIG. 3, each rack 10 can also provide improved retention when multiple surfboards are arranged side-by-side (eg. during transportation, storage or display). The rack also allows for compact multiple surfboard transportation, storage or display, as each rack occupies very little space compared to known holders.

Referring again to FIG. 1, it will be seen that the fingers define a throat T at the entrance space between the fingers and into which a side of the surfboard S is inserted during receipt of the surfboard in the holder between the fingers. A portion of the board then moves into a mouth region M of the rack for retention therein (see FIG. 2). Also, during insertion, the curve or bend in finger 14 causes it to flex to a greater extent than the other finger, imparting a tension in that finger that increases the holding force of the rack 10.

The base region 16 has a relatively rigid backing plate 18 attached thereto to facilitate its firm mounting to a support (eg. to a flat surface or plate of an upright frame, or to a wall etc). The rigid backing plate 18 is typically adhered to a remainder of the base region and may comprise an adhesive-backed rear surface, with a peal-off film 20 attached thereto. The removal of film 20 enables the base to be adhesively mounted to the support.

Other than the rigid backing plate 18, the rack is typically formed from a polymeric foam material, to provide both flexibility and sufficient structural integrity to enable it to function repeatedly. The polymeric foam material can also enhance the frictional gripping of the surfboard between the fingers. The plate 18 may be formed of a non-foamed rigid plastic or other rigid material.

The rack as shown in FIGS. 1 to 3 is laminar. In this regard it comprises a number of layers of polymeric foam materials of differing densities and/or structure (eg. closed-cell and open-cell polymeric foams). For example, the outer layers OL are relatively more rigid (less flexible) and hence more structurally stable than the three inner layers IL. The outer layers comprise a more dense closed-cell polymeric foam and the inner layers comprise a less dense open-cell polymeric foam. This laminar arrangement thus provides both flexibility and strength to the rack.

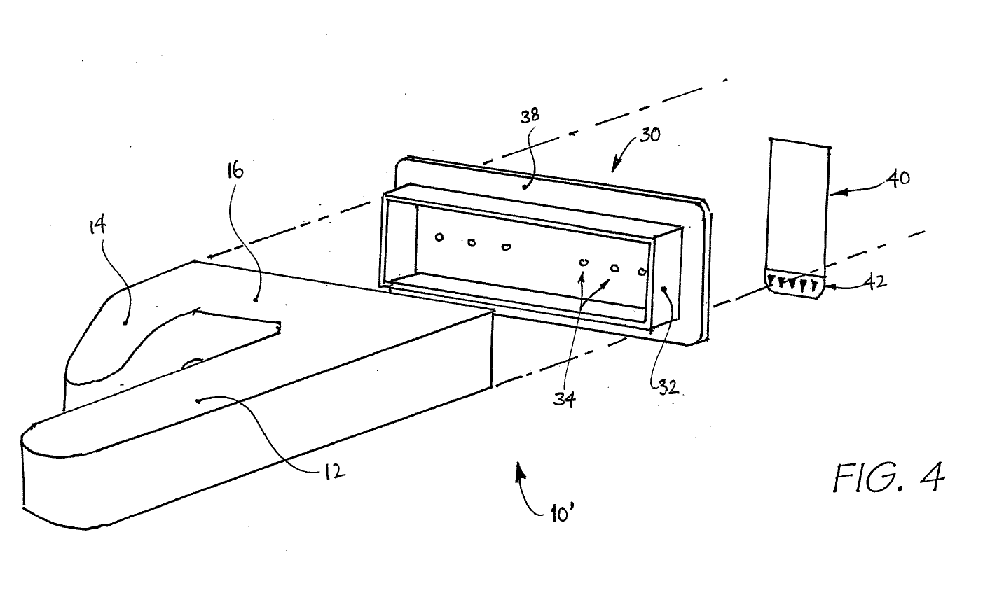

The rack of FIGS. 4 to 7 can be moulded from a single, unitary polymeric foam material for simplicity of formation and cost reduction.

In the mode of use depicted in FIGS. 2 and 3, the rack 10 is positioned on a support (eg. wall W) so as to hold a respective surfboard in an upright configuration. However, the racks 10 may equally be positioned to hold surfcraft in horizontal or other configurations (eg. with the straight finger 12 forming an underlying support in use).

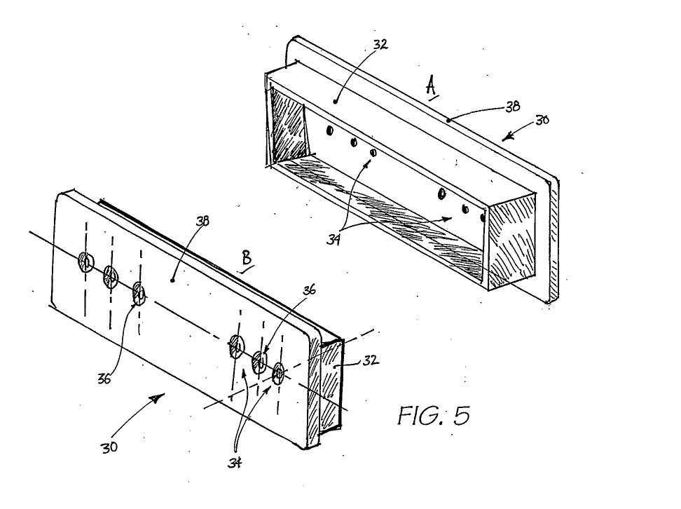

Referring now to FIGS. 4 and 5, where like reference numerals are used to denote similar or like parts, a second holder in the form of a rack 10′ for holding surfcraft such as surfboards and the like is shown. The structure and performance of the rack 10′ is essentially the same as rack 10, so will not be re-described. However, a different mounting system is employed for mounting the rack 10′ to a wall or similar and will now be described.

In this regard, the base region 16 of rack 10′ is hollowed out (or has a rectangular groove cut thereinto) at a wall facing surface thereof. A rigid end cap 30 (eg. of a moulded plastic) can then be attached to the base region 16 to enable firm and easy mounting of the rack 10′ to eg. to a flat surface of a wall, upright, frame etc. Thus, a projecting skirt 32 of end cap 30 is inserted into the hollowed-out or grooved part of base region 16. Alternatively, the projecting skirt 32 of end cap 30 can receive the base region 16 therein.

In either case the end cap can be fastened to the base region by introducing (eg. self-tapping) screws through holes 34 in cap plate 38, which bite and fasten into the material of the base region 16. The holes 34 are counter-sunk at 36 for a flush screw receipt.

The resulting external flat face at plate 38 can then be rapidly and easily adhered to a wall etc by attaching an adhesive-backed tape 40 thereto (eg. double-sided tape), with the tape 40 having a peal-off film 42 attached thereto. The removal of film 42 enables the end cap 30 to be adhesively mounted to a wall etc, thus providing for secure, rapid and easy mounting of the rack.

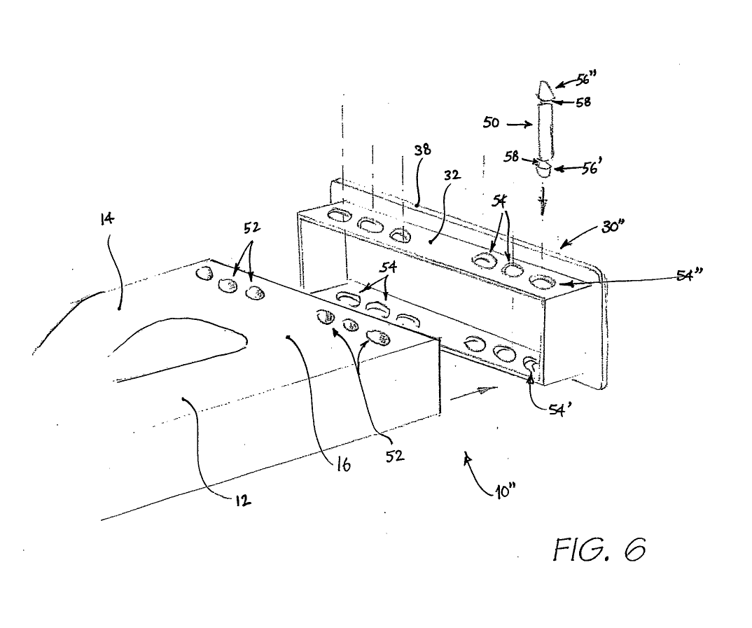

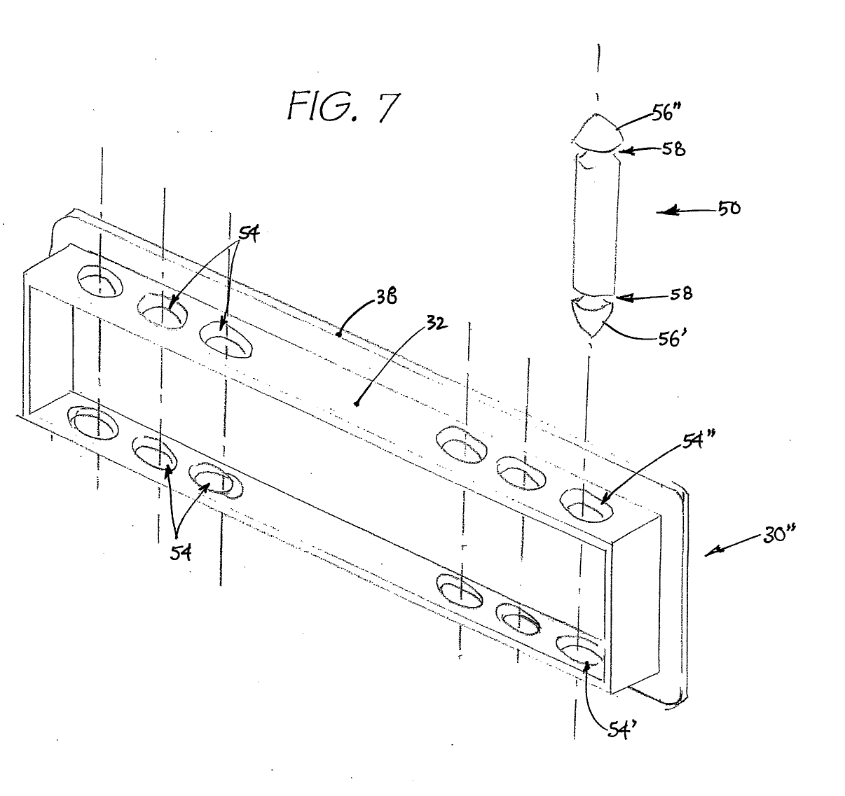

Referring now to FIGS. 6 and 7, where like reference numerals are used to denote similar or like parts, a third holder in the form of a rack 10″ for holding surfcraft such as surfboards and the like is shown. Again, the structure and performance of the rack 10″ is essentially the same as rack 10, so will not be re-described. However, another mounting system is employed for mounting the rack 10″ to a wall or similar and will now be described.

In this case the base region 16 of rack 10″ is mounted into a rigid end cap 30″ (eg. of a moulded plastic) that is then attached thereto to enable firm mounting of the rack 10″ to a flat surface of a wall, upright, frame etc.

In this case, a projecting skirt 32 of end cap 30″ receives the base region 16 therein. The end cap is then fastened to the base region by introducing pins 50 through lateral holes 52 formed in the base region 16, and through holes 54 formed in the projecting skirt 32, with the holes 54 aligning with the holes 52 when the projecting skirt 32 is positioned in the base region 16. Each pin has an enlarged head 56 at opposing ends thereof, with each head defining an adjacent shoulder 58 in the pin.

Each head is adapted for insertion through respective aligned holes 52, 54 and the heads 56 are sized such that, during insertion through holes 54, deformation occurs of either or both of the head and skirt wall adjacent to the holes 54. Thus, once a first pin head 56′ has passed through a first hole 54′, and a second pin head 56″ has passed through a second hole 54″, the pin shoulders 58 are retained at the projecting skirt 32 to attach the pin thereto. The first and second pin heads thus now sit within respective lateral holes 52 in the base region 16, thereby retaining the end cap 30″ on the base region 16.

An external end face of cap plate 38 can again be rapidly and easily adhered to a wall etc by attaching the adhesive-backed tape 40 thereto, with the removal of film 42 enabling the end cap 30″ to be adhesively mounted to a wall etc, again providing for secure, rapid and easy mounting of the rack.

With the rack 10″, the end cap 30″ can be pre-attached to a wall etc, because of the lateral insertion of the pins 50 (ie. the remainder of the rack can be mounted later to the end cap 30″).

The rigid backing plate 18, end caps 30, 30″, and pins 50 are typically moulded from a rigid plastic (eg. HDPE, polypropylene, nylon etc). The fingers and base region of each of the racks are typically formed from a polymeric foam material, to provide both flexibility and sufficient structural integrity to enable the racks to function repeatedly. As mentioned above, the polymeric foam material can enhance the frictional gripping of the surfboard between the fingers.

The polymeric foam material may comprise low and high density polyurethane, polyethylene, polypropylene, acrylonitrile butadiene styrene, poly vinyl acetate foams etc. The rack may also be co- or bi-moulded from plastic foams, with the simultaneous forming of softer or more flexible foams at the central regions and more rigid foams at the exterior regions thereof. This can maintain rack integrity.

Also, by moulding from plastic foams different aesthetic effects can be achieved, such as different colours, textures and shapes.

The racks can alternatively be formed of composite materials include panels of other materials (eg. rigid plastics, natural materials such as timber etc).

Whilst specific embodiments of a holder in the form of a rack have been described, it should be appreciated that the holder can be provided in many other forms.

For example, each finger may be curved, or each finger may be straight. The straight and curved fingers may each have an interior surface profile that matches the particular surfcraft surface shape to be positioned thereagainst.

Also, whilst the holder finds particular application with surfcraft such as surfboards and the like, it should be appreciated that it can be readily adapted for wave jumpers, sail boards, wake boards, surf skis, body boards etc.

In the claims which follow and in the preceding description, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the holder.

1. A holder for holding surfcraft, the holder comprising first and second members projecting from a base, with at least one of the first or second members being able to flex with respect to the base, and wherein the first and second members are spaced such that a surfcraft may be positioned sideways and interferingly between the members, whereby the at least one member can flex to receive the surfcraft interferingly therebetween.

2. A holder as claimed in claim 1 wherein both the first and second members can flex with respect to the base.

3. A holder as claimed in claim 1 wherein each of the members and base are formed as an integral unit.

4. A holder as claimed in claim 3 wherein the base is also flexible.

5. A holder as claimed in claim 1 wherein each member is a flexible finger, with each finger being spaced apart and extending outwardly from a respective opposing end of the base.

6. A holder as claimed in claim 1 wherein one of the fingers is adapted to curve or bend inwardly at a distal end thereof towards the other finger, which is itself straight.

7. A holder as claimed in claim 6 wherein the curve or bend in the one finger causes it to flex to a greater extent than the other finger, imparting a tension in that finger that increases the holding force of the holder.

8. A holder as claimed in claim 1 wherein the fingers define a throat configuration at an entrance space between the fingers and into which a side of the surfcraft is inserted during receipt of the surfcraft in the holder between the fingers.

9. A holder as claimed in claim 1 wherein the base comprises a relatively rigid backing to facilitate its firm mounting to a support.

10. A holder as claimed in claim 9 wherein the rigid backing is adhered to a remainder of the base and further comprises an adhesive-backed rear surface, with a removable film cover thereover, the removal of which enables the base to be adhesively mounted to the support.

11. A holder as claimed in claim 9 wherein the rigid backing is a separate end cap attachable to the base via fasteners.

12. A holder as claimed in claim 11 wherein the end cap is attachable to the support via an adhesive film or tape that is attached to an external end face of the end cap, with a removable film cover being positioned over the film or tape, the removal of which enables the end cap to be adhesively mounted to the support.

13. A holder as claimed in claim 1 wherein the holder is formed from a polymeric foam material.

14. A holder as claimed in claim 1 wherein the holder is laminar, comprising layers of polymeric foam materials of differing densities and/or structure.

15. A holder as claimed in claim 14 wherein some of the layers are relatively more rigid and structurally stable than others.

16. A holder as claimed in claim 1 wherein the holder in use is positioned on a support so as to hold a surfcraft in an upright or horizontal configuration.

17. A holder as claimed in claim 1 that is adapted for use with a surfboard.
